(19) United States
(12) Patent Application Publication
(10) Pub. No.: US 2008/0088655 A1
(43) Pub. Date: Apr. 17, 2008

(54) LIQUID EJECTING APPARATUS

(75) Inventors: Narihiro Oki, Matsomoto-shi (JP); Tsunenobu Endo, Matsumoto-shi (JP); Hidetoshi Kodama, Matsumoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: Seiko Epson Corporation, Tokyo (JP)

(21) Appl. No.: 11/852,074

(22) Filed: Sep. 7, 2007

(30) Foreign Application Priority Data
Sep. 8, 2006 (JP) 2006-244720
Aug. 7, 2007 (JP) 2007-205038

(51) Int. Cl. B41J 29/38

(52) U.S. Cl. 347/10

(57) ABSTRACT

It is possible to prevent the flight velocity of liquid from being increased to an excessive level in a recording unit 110.

An liquid ejecting head includes a recording head having a conductive nozzle plate 252 and discharging ink toward recording paper 150, a recording head control unit 262 changing the ink discharge velocity of the recording head, an absorbing member 236 absorbing the ink which is ejected from the recording head but not attached to the recording paper 150, an electrode disposed close to the absorbing member 236, a voltage source 270 forming an electric field by creating a potential difference between the nozzle plate 252 and the electrode 310 by applying the electrode 310 so the ink ejected from the recording head is electrically attracted to the electrode 310, and an ink collecting operation control unit 264 starting or stopping voltage application by the voltage source 270, in which the recording head control unit 262 decreases the ink discharge velocity when the ink collecting operation control unit 264 enables the voltage source 270 to start the voltage application.

### BACKGROUND OF THE INVENTION

1. Field of the Invention

The present invention relates to a liquid ejecting apparatus, and more particularly to a liquid ejecting apparatus which attaches liquid ejected from orifices of a nozzle plate mounted in a liquid ejecting head to a recording object.

2. Description of the Related Art

In liquid ejecting apparatuses, when attaching liquid to the entire area of a recording object leaving no margin uncovered with the liquid near the edges of the recording object, the liquid is ejected to over a slightly wider area than the dimension of the recording object, considering inevitable misalignment between the recording object and the liquid ejecting head. Accordingly, the liquid is also ejected to a region where the recording object is not present, which is near the side edges and the upper and lower edges of the recording object. Accordingly, an absorbing member is disposed outside the recording object at a position facing the liquid ejecting head so as to absorb the remainder of the liquid which is ejected from the liquid ejecting head but not attached to the recording object. With such a structure, it is possible to prevent outskirts of the recording object from being smudged by the remainder of the liquid which is not attached to the recording object.

By the way, when the liquid is attached to the recording object, a portion of the recording object, to which the liquid is attached, is apt to expand and to thereby wrinkle. If wrinkles come into contact with the absorbing member, the liquid absorbed in the absorbing member may contaminate the recording object. Accordingly, in a number of liquid ejecting apparatuses, a gap of 2 mm to 4 mm is provided between the recording object and the absorbing member, considering the height of the wrinkles of the recording object. In similar manner, in order to prevent the recording object from being smudged due to the contact between the wrinkles of the recording object and the absorbing medium, a gap of 1 mm is provided between the nozzle plate and the recording object. Accordingly, in total, a gap of 3 mm to 5 mm is provided between the nozzle plate and the absorbing member.

On the other hand, on purpose to enhance resolution of an image formed on the recording object by attaching the liquid to the recording object, liquid drops are ejected from orifices of the nozzle plate is atomized further. A single liquid drop has a size of several pl. Since each of such minute liquid drops has very a small mass, the liquid drops rapidly lose their kinetic energy due to viscous resistance of ambient gas after they are discharged from the nozzle plate once. For example, after liquid drops each having a size smaller than 8 pl travel a distance of about 3 mm in the air, flight velocity of the liquid droplets decreases to almost zero. It takes a long period for the minute liquid drops that completely lost their kinetic energy to fall to a target position because the falling motion attributable to the gravitational acceleration and the viscous resistance of ambient are balanced. The liquid drops suspending in the air until they arrive at the target position is called aerosol.

Some of the aerosol produced in such a manner escapes from the liquid ejecting apparatus, suspending away outward and then sticks to objects in surroundings. On the other hand, most of the aerosol sticks to elements in the liquid ejecting apparatus. In the case in which the aerosol sticks to a transportation path of the recording object, such as platen, succeeding recording objects become contaminated due to reattaching of the aerosol. In the case in which the aerosol is attached to electric circuits, linear scales, rotary encoders, optical sensors, and the like mounted in the liquid ejecting apparatus, the attachment of aerosol brings about device malfunction. In addition, if a user touches a spot to which the aerosol is attached, the user's hand gets stained.

The following patent document discloses a liquid ejecting apparatus having a function of actively collecting aerosol using an electric field. In the liquid ejecting apparatus disclosed in the document, an absorbing member is arranged in a position facing a nozzle plate on purpose to attract and absorb the remainder of the liquid drops which is not attached to the recording object. A metal member serving as one electrode is arranged close to the absorbing member and the nozzle plate made of a metal and provided with orifices, from which liquid is ejected, serves as a counter electrode.

If different voltages are applied to the electrode and the nozzle plate, respectively, an electric field is generated between them. On the other hand, liquid drops ejected from the nozzle plate are electrified to have the same polarity as the nozzle plate due to lighting rod effect as soon as the liquid drops are ejected from the nozzle plate. Accordingly, minute liquid drops which can become aerosol continuously fly toward the electrode without velocity loss thanks to Coulomb force generated by the electric field, and are then attached to the electrode having the reverse polarity. Further, the liquid drops attached to the electrode are absorbed by the absorbing member arranged close to the electrode by capillarity.

Patent Document: JP-A-2004-202867

### SUMMARY OF THE INVENTION

As described above, it can be seen that it is possible to suppress generation of aerosol which suspends in the air due to an electric field by the use of the electrified state of the aerosol. However, Accordingly, new technical tasks attributable to the act that an electric field supplements kinetic energy of liquid drops have arisen.

One of them is what flight velocity of ejected liquid in the case in which kinetic energy is supplemented by an electric field temporarily exceeds optimum velocity although speed of liquid ejection from a liquid ejecting head is set to be suitable for the case in which an electric field does not exist. It happens that liquid drops flying at excessive velocity break during flight into satellite ink which is more minute than the liquid drop, and this leads to generation of fresh aerosol contaminating a region outside a recording object.

Further, if an electric field affected liquid drops which has sufficient mass and thus can arrive at an absorbing member, bearing up against resistance of air, collision speed when the liquid drop collides with the absorbing member is increased. For such a reason, it happens that sprays are generated from the liquid droplets and this leads to generation of fresh aerosol contaminating the back surface of a recording object.

A liquid ejecting apparatus includes a liquid ejecting head which is provided with a conductive nozzle plate with orifices and which ejects liquid toward a recording object from the orifices thereof, an absorbing member being disposed at a position farther from the liquid ejecting head in a liquid ejecting direction than the recording object so as to face the nozzle plate, and absorbing the remainder of the liquid, which is ejected from the liquid ejecting head but not attached to the recording object, an electrode arranged close to the absorbing member, a potential difference creating unit creating a potential difference between the nozzle plate and the electrode by applying a voltage to the electrode so as to form an electrical field between the nozzle plate and the electrode so the liquid ejected from the liquid ejecting head is electrically attracted to the electrode, a liquid collection control unit performing switching of the potential differences with respect to the electrodes, and a liquid ejecting head control unit which is a liquid ejecting head control unit controlling operation of the liquid ejecting head so the liquid ejecting head to eject the liquid and performing switching of driving conditions in association with the switching of the potential differences, which is performed by the liquid collection control unit.

To this end, it is possible to prevent the flight velocity of the liquid droplets ejected from the liquid ejecting head to become excessively faster, and thus it is possible to suppress generation of satellite ink attributable to the excessive flight velocity.

It is preferable that the liquid collection control unit can switch the potential difference between a first potential difference and a second potential difference which is larger than the first potential difference, the liquid ejecting head control unit ejects the liquid under a first driving condition so as to respond to the first potential difference, and ejects the liquid under a second driving condition so as to respond to the second potential difference, in which the second driving condition is slower than the first driving condition with respect to an initial velocity is the liquid which is being ejected and is substantially the same as the first driving condition with respect to an amount of ejected liquid.

It is preferable that an arrival velocity of the liquid at the recording object, the liquid ejected under a condition of the first potential difference and under the first driving condition with the first potential difference is almost the same as an arrival velocity of the ejected liquid at the recording object, the liquid ejected under a condition of the second potential difference and under the second driving condition.

It is preferable that the liquid ejecting head control unit performs switching of driving signals supplied to a driving element which imparts a pressure to the liquid in the orifices.

It is preferable that the liquid collection control unit stops voltage application when a case body of the liquid ejecting apparatus is opened. Accordingly, it is possible to prevent the electrode from being in an uncovered state when a voltage is applied to the electrode. This, safety of the liquid ejecting apparatus is enhanced.

It is preferable that the liquid collection control unit stops the voltage application when which it is detected that foreign matter other than the recording object exists in the case body.

### BRIEF DESCRIPTION OF THE DRAWINGS

FIG. 1 is a perspective view illustrating overall structure of a recording reading multifunction device.

FIG. 2 is a perspective view illustrating an internal mechanism of a recording unit by drawing the internal mechanism out of the recording unit.

FIG. 3 is a top view taken by viewing the internal mechanism from the upper side thereof.

FIG. 4 is an exploded perspective view illustrating structure of only a platen.

FIG. 5 is a sectional view illustrating main part of an internal structure of an exemplary recording head.

FIG. 6 is a timing diagram illustrating exemplary driving signals.

FIG. 7 is a block diagram illustrating structure of a recording head control unit.

FIG. 8 is a conceptual view explaining operation of an aerosol collecting mechanism.

FIG. 9 is a view schematically illustrating overall structure of a system including the recording reading multifunction device.

FIG. 10 is a view schematically illustrating structure of a control system in the system shown in FIG. 6.

FIG. 11 is a timing diagram showing conditions of every element in the recording unit.

FIG. 12 is a timing diagram showing conditions of every element in the recording unit.

FIG. 13 is a timing diagram showing conditions of every element in the recording unit.

FIG. 14 is a flow chart illustrating sequence of additional controls by a control unit while the recording operation is continued.

FIG. 15 is a view illustrating the comparison result of conditions of all elements in the recording unit.

### DESCRIPTION OF THE PREFERRED EMBODIMENTS

Hereinafter, the invention is described with reference to embodiments of the invention but the following embodiments are not understood to limit the scope of the invention relating to claims. Further, it does not always mean that combinations of all features described in the embodiments are necessary for means for solving the problems.

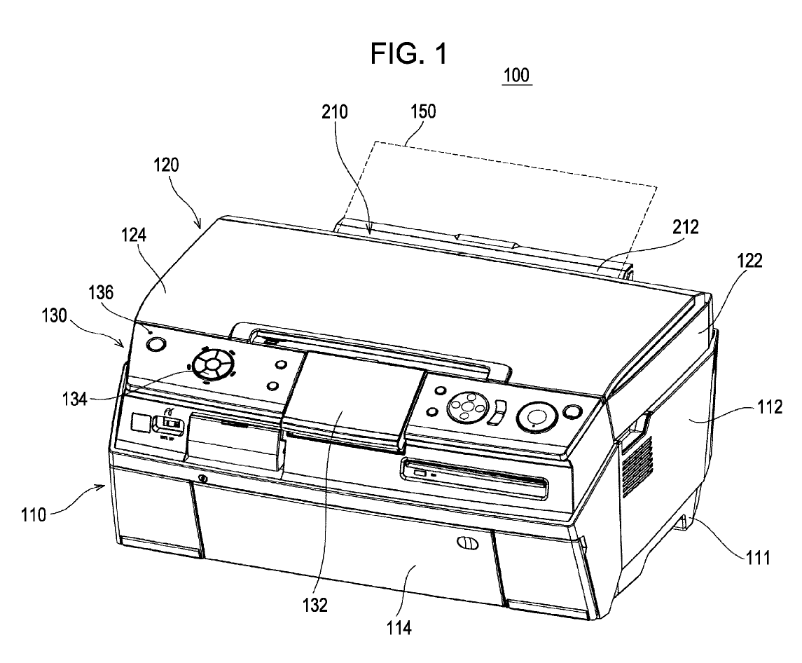

FIG. 1 is a perspective view showing appearance of a recording reading multifunction device 100 including an ink jet type recording device which is one of embodiments of the invention. As shown in the same figure, the recording reading multifunction device 100 is formed by including both a recording unit 110 and a reading unit 120 overlapping over the recording unit 110.

The reading unit 120 is formed in a case body serving as an upper casing 122 of the recording reading multifunction device 100. A reading table, which can press a manuscript to be read out, is arranged on the upper surface of the upper casing 122, and an upper cover 124 serving as a manuscript pressure which presses the manuscript disposed on the reading table is additionally installed.

On the other hand, the recording unit 110 is formed on a casing lower portion 111 in a case body which also functions as a lower casing of the recording reading multifunction device 110. In this figure, it is shown that a paper support 212 of a feeding unit 210 which will be described below is disposed at a back portion of the upper casing 122. Further, a front cover 114 having a discharging tray 248 (which will be disclosed below) on a back surface thereof is depicted in the closed state while it is provided on a front surface of the lower casing 112.

The recording reading multifunction device 100 is further provided with a manipulation panel 130 on the front side of the upper cover 124. The manipulation panel 130 is provided with a display panel 132, a plurality of manipulation buttons 134, and a pilot lamp 136.

In the recording reading multifunction device 100, with respect to the manuscript mounted on the reading unit 120 after opening the upper cover, the manuscript is read out from the underside thereof. The recording paper 150 mounted on the paper support 212 is transported forward in the recording unit 110 by an internal mechanism 200 which will be described, and an image is recording during such a procedure.

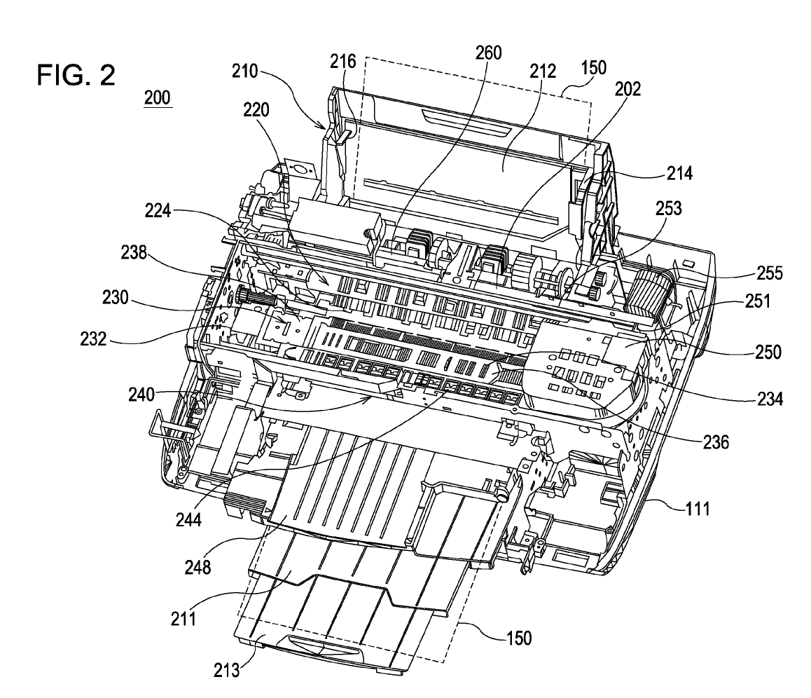

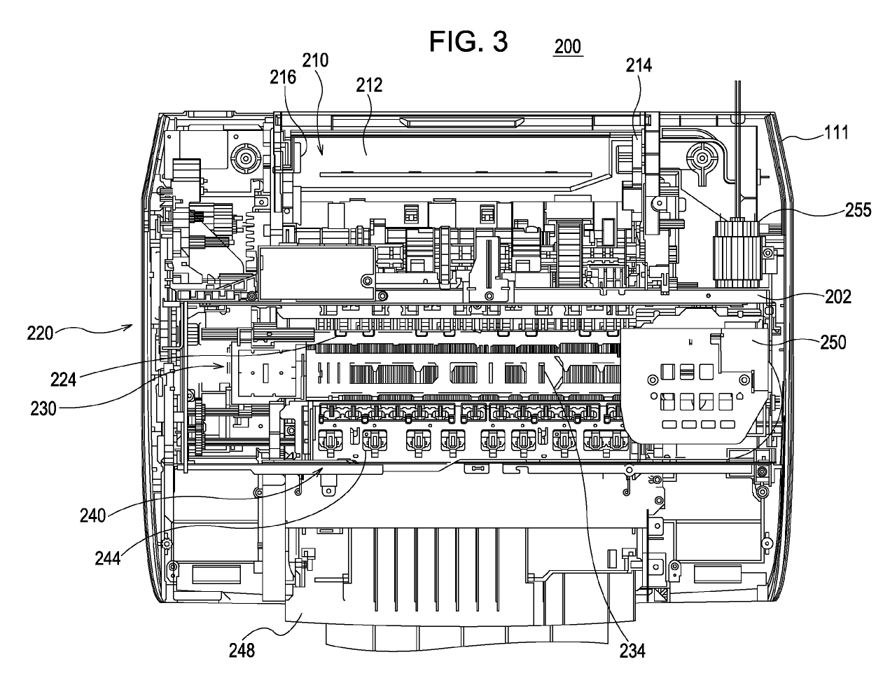

FIG. 2 is a perspective view illustrating the internal mechanism 200 of the recording unit 110 drawn out from the recording reading multifunction device 100 shown in FIG. 1. FIG. 3 is a plan view taken by observing the internal mechanism 200 from the top side thereof. As shown in the figures, the internal mechanism 200 includes a casing bottom 111, a frame 202 standing erect on the casing bottom 111, a feeding unit 210 disposed on the back side of the frame 202, and a transporting unit 220, a platen 230, and a discharging unit 240 which are arranged in this order in front of the frame 202.

The feeding unit 210 includes a paper support 212 supporting a back surface of the recording paper 150 charged in a longitudinal direction, a side support 214 determining location of the right side edge of the recording paper 150, and a slide support 216 disposed close to the left side edge of the recording paper 150 and preventing the recording paper 150 from inclining. The slide support 216 can horizontally move on the surface of the paper support 212 and thus can abut against the side edge of the recording paper 150 even in the case in which the recording paper 150 having different sizes in width are electrified. The feeding unit 210 further includes a feeding roller hidden behind the frame 202 and introduces a plurality of recording paper 150 mounted on the paper support 212 into the internal mechanism 200 sheet by sheet while the recording unit 110 performs recording.

In addition, the internal mechanism 200 further includes a horizontal paper support 211 of which the front side is open, which is disposed in a lower position of the discharging tray 248 which will be described below. The paper support 211 supports the recording paper 150 from the underside, which is horizontally charged from the front side of the internal mechanism 200. Further, it is possible to send the recording paper 150 which is horizontally charged so as to be on the paper support 211 to the transporting unit 220 using the feeding unit 210. The paper support 211 includes an extended portion 213 and can support the recording paper 150 which is longer than the depth thereof.

The transporting unit 220 includes a transportation driven roller 224 serving as a paper feeding roller which is arranged right in front of the frame 202, abuts against the upper surface of the introduced recording paper 150, and thus is rotated. A transportation driving roller rotated by a transporting motor (not shown) is arranged right under the transportation driven roller 224. Accordingly, the recording paper 150 introduced into the internal mechanism 200 is tightly held by the transportation driving roller 224 and is transferred so as to be on the platen 230 as the transportation driving roller is rotated.

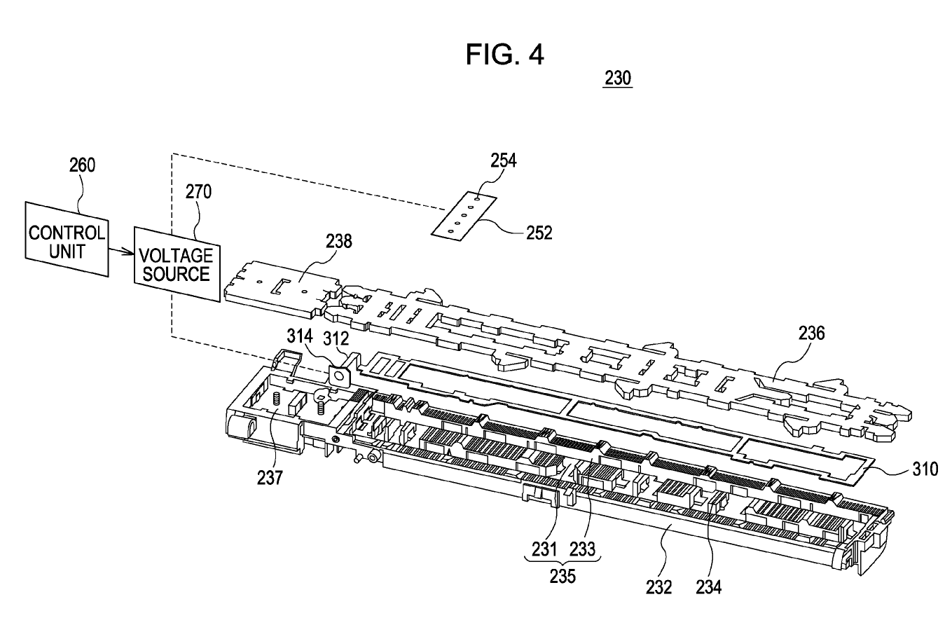

The platen 230 has a plurality of ribs 234 protruding upward. The ribs 234 abut against the lower surface of the transferred recording paper 150 at their leading ends, thereby determining the height and the orientation of the recording paper 150. The recording paper 150 passed over the platen 230 finally comes to arrive at a discharging unit 240. The structure of the platen 230 will be additionally described later with reference to FIG. 4 in detail.

The discharging unit 240 is arranged in front of the platen 230 and is equipped with a discharge driven roller 244 rotated by abutting against the upper surface of the recording paper 150 transferred passing over the platen 230. A discharge driving roller, rotationally driven by a transporting roller via a rotation transferring mechanism (not shown), is arranged right under the discharge driven roller 244. The recording paper 150 is tightly pressed against the transportation driving roller by the discharge driven roller 244, and the discharge driving roller sends the recording paper 150 to the front side of the recording unit 110 by the rotating motion thereof. A discharging tray 248 is arranged in front of the discharging unit 240, and the discharged recording paper 150 is stacked on the discharging tray 248.

In addition, the internal mechanism 200 includes a carriage 250 reciprocating above the platen 230. That is, the carriage 250 is installed so as to horizontally move in a longitudinal direction along a guide member (not shown) which is disposed in front of the frame 202 and extends in the longitudinal direction. A timing belt 253 is arranged in front of the frame 202 so as to elongate between a pair of pulleys 251. The carriage 250 is connected to the timing belt 253 at the back surface thereof.

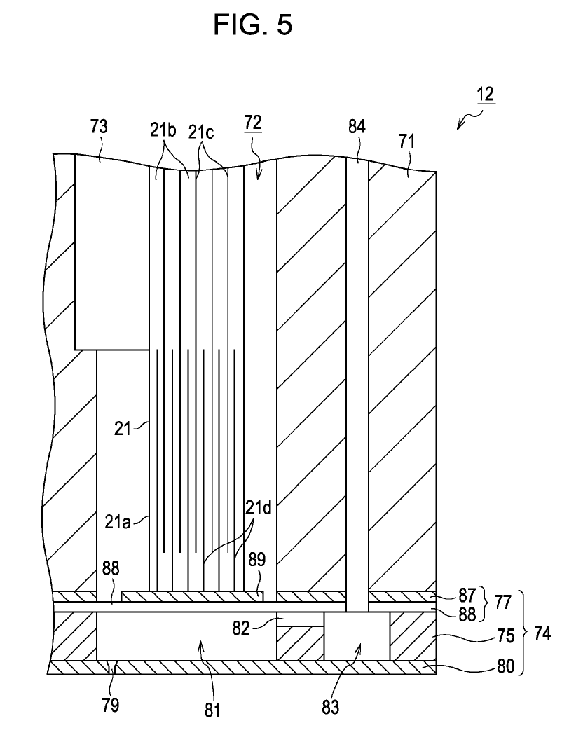

One pulley 251 is rotationally driven by a carriage motor 255, and thus the carriage 250 moves according to the displacement of the timing belt 253. Accordingly, it is possible to move the carriage 250 upward from an arbitrary region on the platen 230 by controlling operation and rotating direction of the carriage motor 255. The carriage 250 is provided with the liquid ejecting head (shown FIG. 5) having a nozzle plate on the lower surface thereof. Accordingly, the carriage 250 can eject ink toward an arbitrary region on the platen 230.

In the recording reading multifunction device 100 including the internal mechanism 200 having such a structure, recording paper 150 charged on the paper support 211 on the front side or on the paper support 212 on the back side is introduced into the transporting unit 220 by the feeding unit 210 sheet by sheet. The recording paper 150 introduced into the transporting unit 220 passes over the platen 230, then arrives at the discharging unit 240, and finally is sent out of the internal mechanism 200 by the discharging unit 240.

When the recording paper 150 exists on the platen 230, the liquid ejecting head discharges ink downward while the carriage 250 performs reciprocating motion above the platen 230. As a result, the ink is discharged to and can be attached to an arbitrary region on the surface of the recording paper 150. In addition, the recording paper 150 is intermittently transported by an amount of one row, and the carriage 250 reciprocally moves in a period in which transporting motion is suspended. Thus, it is possible to record an image over the entire surface of the recording paper 150.

A control unit 260 controlling a series of recording operations is mounted on the back surface of the frame 202. The control unit 260 controls the recording unit 110 so as to perform proper operations on the basis of instructions inputted through information devices connected to the recording reading multifunction device 100 and instructions inputted through the manipulation panel 130. The control unit 260 is an interface unit receiving image information to be recorded by the recording unit 110. It happens that the image information inputted to the control unit 260 includes information about recording quality, such as resolution of an image to be recorded and the number of kinds of colors and information about a recording object, such as dimension and material besides information about the image to be recorded.

FIG. 4 is an exploded perspective view illustrating a detailed structure of the platen 230 in the internal mechanism. As shown in the same figure, the platen 230 includes a platen body 232, an electrode 310 received in the platen body 232, and an absorbing member 236, 238.

The platen body 232 is an integrally formed resin material. The platen body 232 includes a plurality of ribs 234 protruding upward from the upper surface thereof, wider receiving portions 235, in which each wider receiving portion is a depression formed on the upper surface of the platen body 232 and defined by the bottom 231 and sidewalls 233 and has a relatively large width, and narrower receiving portions 237 disposed next to a region with the ribs 234 thereon. In the case in which the recording paper 150 passes over the platen 230, the upper ends of the ribs 234 abut against the lower surface of the recording paper 150, and thus, the position (in height direction) of the recording paper 150 is determined.

The absorbing member 236, 238 has a size and a shape that can fill the receiving portions 235 and 2237. A material of the absorbing member 236, 238 is selected considering absorbing speed of liquid on the surface thereof as an important fact. Here, an absorbing capacity of the absorbing member 236, 238 is limited. Accordingly, a waste liquid absorbing member (not shown) having a larger ink absorbing capacity than the absorbing member 236, 238 is additionally disposed under the platen 230.

In addition, the platen 230 includes the electrode 310 disposed under the absorbing member 236 in each of the wider receiving portion 235. The electrode 310 is arranged so as to cover almost the entire bottom 231 of each wider receiving portion 235. An extended portion 312 extending outward so as to protrude from the side wall 233 of the wider receiving portion 235 and a terminal portion 314, which is visible from the outside of the platen 230, are integrally formed and are provided to an end of the electrode 310. The electrode 310 is connected to an end of a voltage source 270 operating under the control of the control unit 260 via the terminal portion 314, and thus it is possible to apply a voltage to the electrode 310. A remaining end of the voltage source 270 is connected to the nozzle plate 252 mounted on the carriage 250. With such a structure, it is possible to create a potential difference between the nozzle plate 252 and the electrode 310 and thus it is possible to generate an electric field.

In addition, a foam of resin such as polyethylene, polyurethane, and the like can be properly exemplified as a material for the absorbing member 236, 238. It is further preferable that the absorbing member 236 be made of a conductive material having a surface resistance equal to or less than 10⁸Ω on purpose to make potentials of the absorbing member 236 and the electrode 310 equal to each other. As such a material, a material prepared by mixing a conductive material such as metal, carbon, and the like with resin such as polyethylene, polyurethane, and the like and by foaming such a mixture, a material prepared by attaching a conductive material such as metal, carbon, and the like to a resin foam such as polyethylene, polyurethane, and the like, or a material prepared by plating a resin foam such as polyethylene, polyurethane, and the like with a conductive material, such as metal, carbon, and the like can be exemplified. Still further, a material prepared by impregnating a resin foam such as polyethylene, polyurethane, and the like with electrolyte can be used.

On the other hand, as a material for the electrode 310, a metal having corrosion resistance against ink, such as wire, plate, or clad member made of gold, stainless steel, or nickel; wire, plate, clad member plated with such a metal; a net-form member formed by a combination of the above-mentioned ones; and a lattice form member formed by a combination of the above-mentioned ones can be used. According to another embodiment, a coating film layer, a plating layer, a thick film layer, a thin film layer, and the like which are directly formed on the bottom 231 of the receiving portion 235 of the platen 230 can be used as the electrode 310.

FIG. 5 is a sectional view illustrating main part of an internal structure of the recording head. The recording head 12 includes a casing 71 prepared by a resin molding process, a piezoelectric vibrator 21 received in a receiving chamber of the casing 71, and a fluid passage unit 74 connected to the casing 71. The piezoelectric vibrator 21 has a structure including electrodes 21c, piezoelectric bodies 21b, and electrodes 21 alternately stacked. The fluid passage unit 74 is composed of a nozzle plate 80, a fluid passage forming plate 75, and an elastic plate 77 which are stacked.

The piezoelectric vibrator 21 is a plate type vibrator in which the electrodes 21c and the electrodes 24 are alternately stacked with the piezoelectric body 21 in every between. As a voltage (driving signal) is applied across the electrodes 21c and the electrode 21d, all the piezoelectric vibrator 21 expand in a direction perpendicular to a stacking direction.

The fluid passage forming plate 75 has a pressure generating chamber 81, a reservoir 83, and a groove corresponding to an ink supply passage 82 communication with the pressure generating chamber 81 and the reservoir 83. The fluid passage forming plate 75 can be manufactured by, for example, silicon wafer etching processing.

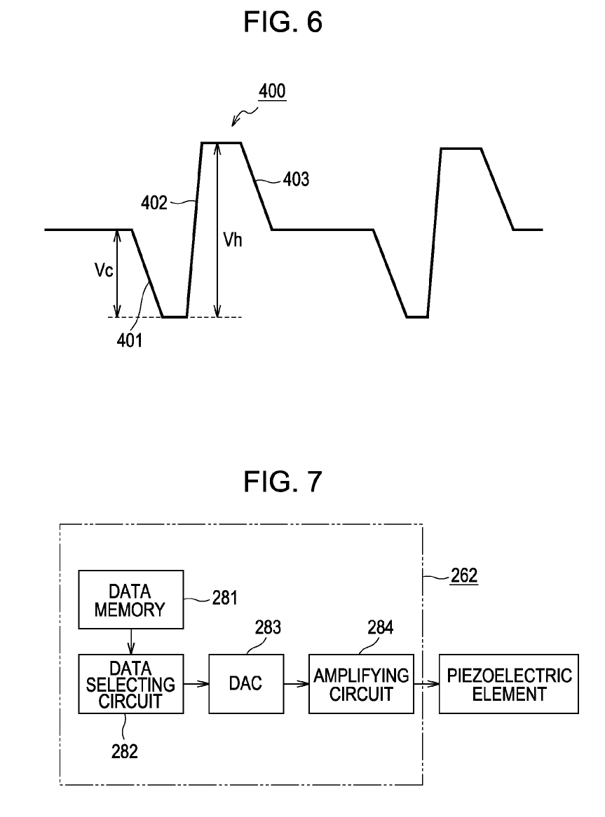

The nozzle plate 80 is a plate-shaped member made of a conductive material, such as a metal, for example SUS, and has nozzles 79 on one surface thereof. The nozzle plate 80 is electrically connected to a terminal of the voltage source (shown in FIG. 6) as described later.

The elastic plate 77 has a double-layer structure including a stainless steel plate 87 and a flexible film 88. A portion of the stainless steel plate 87 is notched by the etching processing and thus an island portion 89 corresponding to a canopy of the pressure generating chamber 81 is formed.

The end of the piezoelectric vibrator 21 in an upper position of the figure is fixed to the inside surface of the wall of the receiving chamber 72 via the metal substrate 73. The end 21a of the piezoelectric vibrator 21 in a lower position of the figure is coupled to the island portion 89.

In this manner, when the piezoelectric vibrator 21 serving as a driving element comes to expand in the longitudinal direction thereof, the island portion 89 is pressed against the nozzle plate 80 so that pressure generating chamber 31 comes to contract. When the piezoelectric vibrator 21 comes to contract in the longitudinal direction in the sate in which the pressure generating chamber 81 has contracted, the island portion 89 moves in a leaving direction from the nozzle plate 80 and thus the pressure generating chamber 81 comes to expand.

The driving control of such a piezoelectric vibrator 21 is executed by a voltage signal (hereinafter, call driving signal) applied across the electrodes 21c and 21d. Condition (amount and size) of ink droplets discharged (ejected) can be controlled by forms of the driving signals (level and slope of voltage change) as described below.

FIG. 6 is a timing diagram illustrating an example of the driving signals. The driving signals in this example is constructed in a manner such that a pulse group including a discharging pulse 401, a charging pulse 402, and a discharging pulse 403 is connected to a medium level potential. If a single pulse group 400 is supplied to the piezoelectric element, a single ink droplet is discharged from a nozzle.

That is, a pressure of an inner space of the nozzle is first decreased by the discharging pulse 401, and thus ink is introduced into the inner space of the nozzle. Next, the pressure of the inner space of the nozzle is increased by the charging pulse 402 with a stiff slope and thus the ink is pushed outward. The pushed ink is separated from the ink in the nozzle and is then discharged from the nozzle as an ink droplet. The last discharging pulse 403 makes the increased potential level becomes the medium level potential and plays a role of eliminating pressure vibrations in the nozzle generated by the charging pulse 402.

A potential difference Vh of the charging pulse, a potential difference Vc of the discharging pulse 401, period components of all the pulses 401 to 403 are parameters in closely association with an amount (discharge amount) of an ink droplet and an initial velocity (discharge velocity). Accordingly, it is possible to accomplish desired discharge amount and discharge velocity by properly designing such parameters. For example, the higher the Vh, there is a tendency that the higher the discharge velocity. There is a tendency that the discharge velocity becomes faster as a ratio of Vc to Vh becomes higher. Accordingly, it is possible to prepare the corresponding discharge velocities varying stepwise as the driving signals for obtaining a predetermined discharge amount (for example, 7 pl).

FIG. 7 is a block diagram illustrating structure of a recording head control unit. The recording head control unit 262 includes a data memory 281, a data selecting circuit 282, a digital/analog (D/A) converter 28, and an amplifying circuit 284.

The data memory 281 stores design digital data for designing a plurality of kinds of driving signals corresponding to discharge velocities changing stepwise. The data selecting circuit 282 selects one piece of the design digital data according to a command which is externally input and sends the selected design digital data to the D/A converter 283. The D/A converter 283 generates an analog signal shown in FIG. 6 on the basis of the design digital data, and the analog signal is amplified by the amplifying circuit and is then supplied to the piezoelectric element.

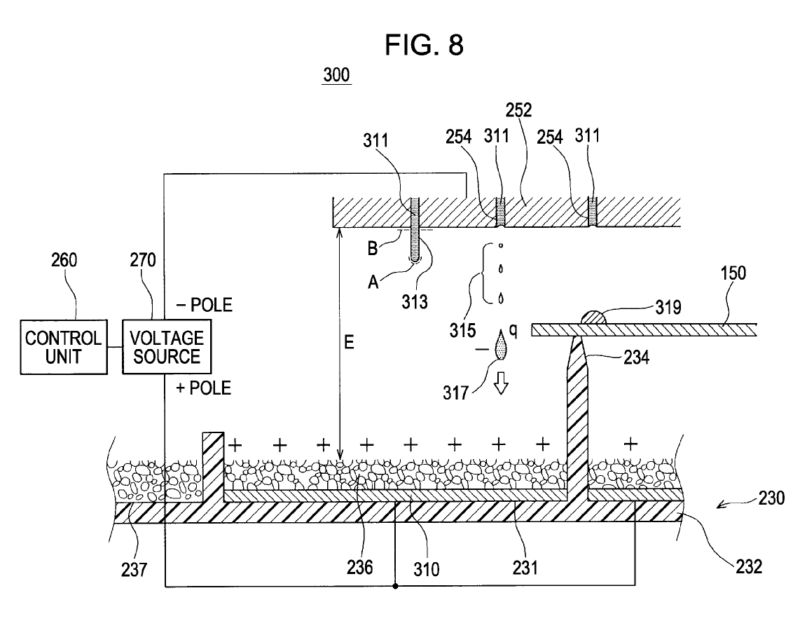

FIG. 8 is a schematic view illustrating the structure and the operation of an aerosol collecting mechanism 300 provided in the internal mechanism 200 of the recording unit 100. The nozzle plate 252 having orifices 254 from which ink is discharged is electrically conductive. The nozzle plate 252 is connected to a negative pole of the voltage source 270. On the other hand, a positive pole of the voltage source 270 is connected to the electrode 310 received in the platen 230. Further, the absorbing member 236 received in the platen 230 while overlapping the electrode 310 is electrically conductive. Accordingly, the whole of the absorbing member 236 and the electrode 310 have the same electrical potential. Therefore, an electric field E attributable to a potential difference created by the voltage source 270 is formed between the lower surface of the nozzle plate 252 and the surface of the absorbing member 236. Further, in the case in which the nozzle plate and the electrode are connected to the reverse poles of voltage source 270, respectively, the same function can be realized.

During the recording operation, the nozzle plate 252 discharges the ink 311 downward through the orifices 254. Here, when the recording paper 150 exists right under the orifices 254, the discharged ink 311 is attached to the upper surface of the recording paper 150 and thus an image 319 is formed. When intending to attach the ink 311 to the recording paper 150 without leaving a margin near the edges of the recording paper 150, it happens that the recording paper 150 does not exist right under some of the orifices 254, disposed near both edges, a front edge, and a back edge of the recording paper 150.

In such a case, kinetic energy imparted to the ink droplets 317 when the ink droplets 317 are discharged from the orifices 254 is rapidly extinguished due to viscous resistance of the ambient. For this reason, the ink droplets 317 lost the kinetic energy long before they reach the conductive absorbing member 236. Since each ink droplet 317 has a very small mass, when the ink droplets 317 lost their kinetic energy, falling motion attributable to acceleration of gravity and viscous resistance are balanced, and thus falling velocity becomes vary slow. For such a reason, aerosol suspending under the nozzle plate 252 is generated. Further, some of ink droplets 317 breaks into shreds and thus satellite ink 315 which is minuter than the ink droplet is formed and this also becomes aerosol.

However, in such an aerosol collecting mechanism 300, the electric field E is formed between the surface of the absorbing member 236 and the lower surface of the nozzle plate 252. Accordingly, each ink droplet 317 having a charge q obtains its kinetic energy due to Coulombic force Fe (qE) applied by the electric field E, moves downward without velocity loss, and reaches the absorbing member 236.

In addition, the ink 311 which is forced out of the orifices 254 forms ink pillars 313 drooping from the nozzle plate 252 at a moment right before it becomes ink droplets 317 after leaving the nozzle plate 252. At this time, charges are accumulated between leading ends A of the ink pillars 313 and regions B near the ink pillars 313 on the lower surface of the nozzle plate 252 due to lighting rod effect. Due to the lighting rod effect, the ink droplet 317 is electrified with a charge q larger than a charge corresponding to a horizontal sectional area of each ink pillar 313. In addition, the lighting rod effect means a phenomenon that a region B of the surface of the nozzle plate 252, which is surrounded in a circular corn having the top, which is the leading end A (the lower end in the figure) of the ink pillar 313, and a vertex angle in the range from 50° to 60° contributes to electrification of the ink droplet 317. To this end, the ink droplet 317 flies to the absorbing member 236 with the stronger Columbic force applied thereto in the middle of electric field E.

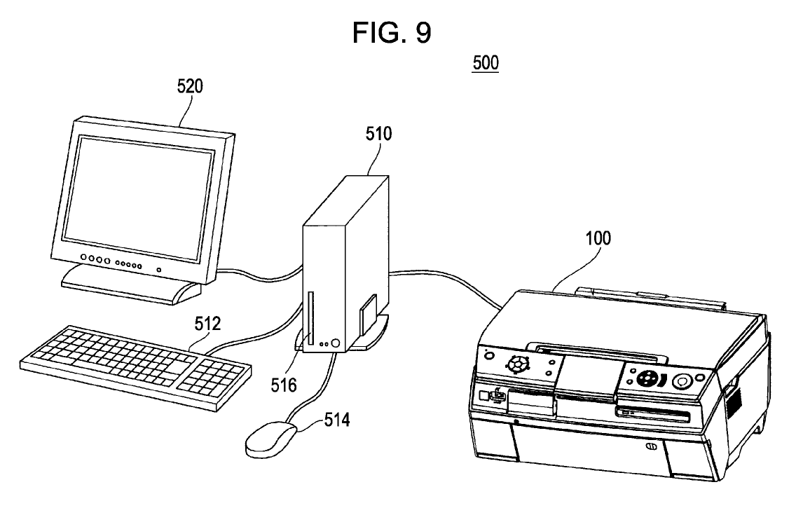

FIG. 9 is a view schematically illustrating structure of a system having the recording reading multifunction device 100 including the recording unit 110 provided with the above-described aerosol collecting mechanism 300. As shown in the same figure, as shown in the same figure, in the system 500, the control unit 260 of the recording reading multifunction device 100 is connected to an information processing device 510 serving as a host device. The information processing device 510 includes a keyboard 512 and a mouse 514 which are input units to receive input data from a user, and a display device 520 which displays an image to a user.

The information processing device 510 includes a disk driver 516 which read can record information from and into the recording paper and a communication line (not shown) which can allow information exchange by communication with external devices. Accordingly, the information processing device 510 can prepare image information to be recorded onto the recording paper mounted in the disk driver 516 or into the recording unit 110 via the communication line besides image information which is internally produced. Further, a program controlling the recording reading multifunction device 100 is externally obtained and then installed.

With such a structure, the information processing device 510 can make a printing instruction to the recording unit 110 by the control unit 260, and can provide the recording unit 110 with the image information to be recorded by the recording unit 110. Further, the information processing device 510 can provide the control unit 260 with the kind of the recording paper 150, recording resolution, and the number of copies to be recorded along with the image information to be recorded.

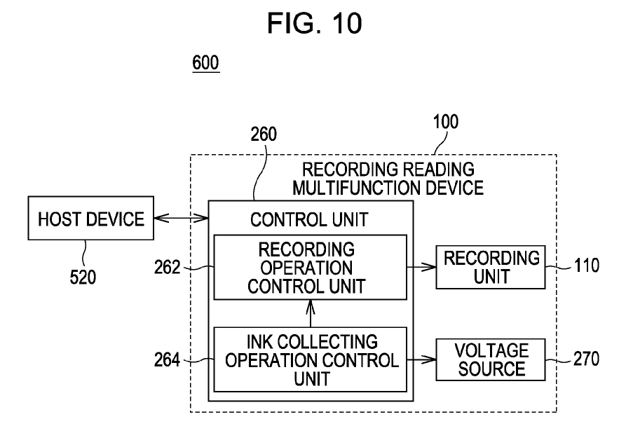

FIG. 10 is a view schematically illustrating a control system 600 in the system 500 shown in FIG. 9. As shown in the same figure, the control unit 260 mounted in the recording unit 110 includes a recording head control unit 262 controlling the recording operation in the recording unit 110, and an ink collecting operation control unit 264 controlling operation of the voltage source 270 in the aerosol collecting mechanism 300.

Accordingly, the recording operation in the recording unit 110 is executed in the recording unit 110 under the control of the recording head control unit 262 on the basis of the instruction that the control unit 260 receives from the information processing device 510 serving as the host device. The voltage source 270 changes the level of the potential difference (voltage) by collaborating with the recording head control unit 262 under the control of the control unit 260 (the control includes the case in which it happens that the potential difference becomes zero by interrupting the voltage source 270.

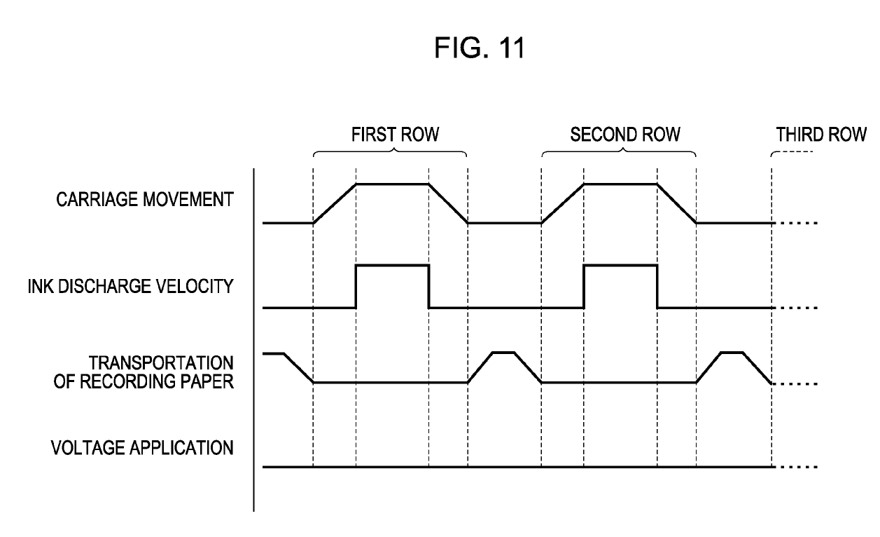

FIG. 11 is a view illustrating conditions of all elements of the recording unit 110 having the above described structure and function in the state in which the aerosol collecting mechanism 300 is not driven, that is, the potential difference generated by the voltage source 270 is set to be zero (a first potential difference). The uppermost portion in the figure indicates movement of the carriage 250 by the moving speed. The second uppermost row indicates movement of the recording head by discharge velocity of ink. The third uppermost row indicates transportation of the recording paper 150 by the change of transportation speed. The lowermost row indicates the operation of the aerosol collecting mechanism 300 according to the change of application voltage.

As shown in the same figure, the carriage 250 moves in the longitudinal direction of the platen 230 from an initial position set to be located at one end of the platen 230 and returns to the initial position when reaching the opposing end of the platen 230. Such reciprocal motion is intermittently repeated. In a period in which the carriage 250 moves, the ink is discharged from the nozzle plate 252, and the image is formed on the recording paper 150. Here, when discharging the ink, the driving signal supplied to the piezoelectric element from the recording head control unit 262 (shown in FIG. 7) is set so as to respond to a relatively high velocity (for example, 7 m/s average) (first driving condition).

If the image in an amount of a single line is printed, the recording paper 150 is transported by an amount corresponding to the single line and then the printing with respect to a succeeding line comes to be in standby state. In this period, processing that the information on an image to be recorded in a subsequent step is transmitted from the host device to the control unit is executed. With the repeat of such a series of operations, it is possible to form an image on the surface of one sheet of the recording paper 150.

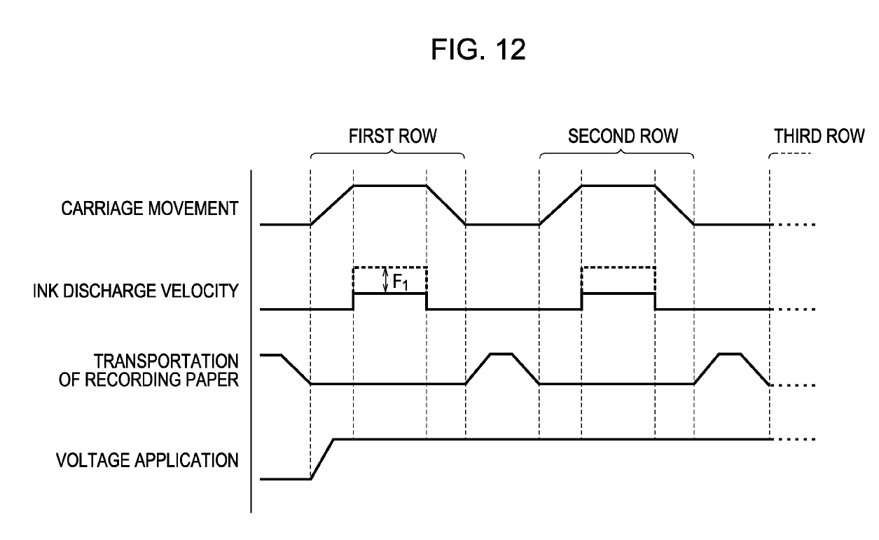

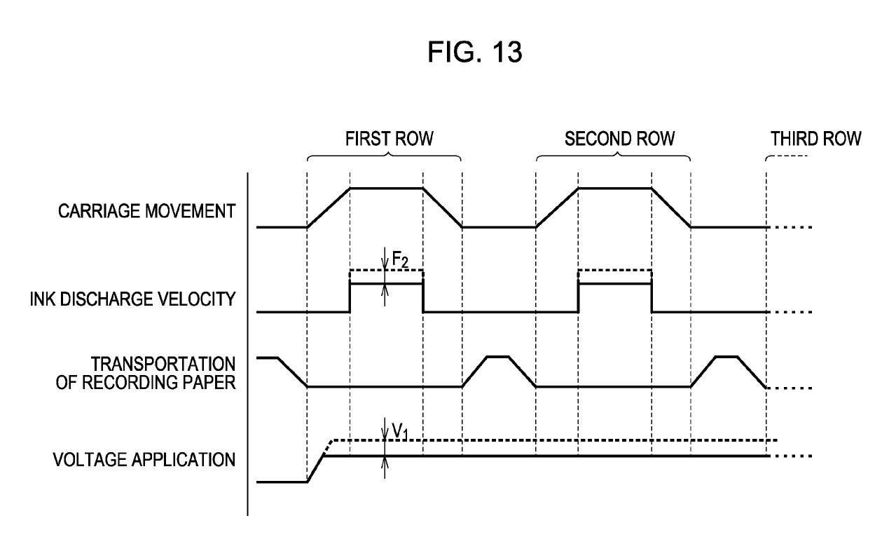

FIG. 12 is a view illustrating conditions of all elements of the recording unit 110 in the state in which the aerosol collecting mechanism 300 is driven, that is, the potential difference generated by the voltage source 270 is set to be greater than zero (a second potential difference). As shown in the figure, a rated voltage is applied before the recording head discharges ink and an electric field which is effective for aerosol collection is formed.

Here, in the operations in association with the figure, as indicated by an arrow F1 in the figure, the driving control relating to the ink discharge is performed so s to decrease the ink discharge velocity. That is, when the ink is discharged, the driving signals supplied to the piezoelectric element from the recording head control unit 262 (shown in FIG. 7) are set to respond to a relatively slow velocity (for example, 6 m/s average)(second driving condition).

To this end, the increase of the flight velocity of the liquid droplets, attributable to the electric field, is offset, and thus generation of the satellite ink and sprays of ink attributable to the excessive flight velocity is suppressed. Further, the discharge velocity of the ink is the velocity at which the discharged liquid can give the kinetic energy by an amount needed for the discharged liquid to be able to reach the recording paper 150 and the absorbing member 236. However, in the case in which the kinetic energy is supplemented by the electric field, the discharge velocity is limited so as for the liquid droplets of ink not to break by the high flight velocity.

As described above, in this embodiment, driving conditions for discharging the ink are adapted so as to be switched according to switching of the potential differences (including operation ON/OFF) in the aerosol collecting mechanism 300, considering the velocity of the ink droplets, affected by the electric field.

FIG. 13 is a view illustrating conditions of all elements of the recording unit 110 under different driving condition. As indicated by an arrow V₁ in the figure, under this driving condition, a voltage applied by the aerosol collecting mechanism 300 in order to form the electric field is lower than that in the operation in association with FIG. 12. Accordingly, the Coulomb force affecting the discharged ink is decreased. Accordingly, as indicated by an arrow F2 in the figure, the discharge velocity of the ink from the recording head can be decreased to variation smaller than that in the case of FIG. 12.

As described above, with the balance between power (voltage) applied to the aerosol collecting mechanism 300 and the discharge velocity of the ink, it is possible to maintain the flight velocity of the ink flying in the form of liquid droplets at an optimum level and to effectively suppress the increase of the satellite ink attributable to the excessive flight velocity and the increase of sprays attributable to collision with the absorbing member.

The velocity of the discharged ink droplets influences on arrival positions of the droplets on the surface of paper, which are relative to the reciprocating direction (scanning direction) of the carriage. That is, in the case in which the velocity of the ink droplets varies according to the levels of the potential differences in the aerosol collecting mechanism 300, a period from discharge timing to arrival timing at the surface of paper also varies. This leads to variation of the arrival positions of the ink droplets. Taking such circumstances into consideration, when switching the above-described driving conditions (discharge velocities of the ink droplets), it is preferable that all driving conditions are set in a manner such that the velocity of the discharged ink droplets on the surface of paper is constant regardless of the generated potential differences.

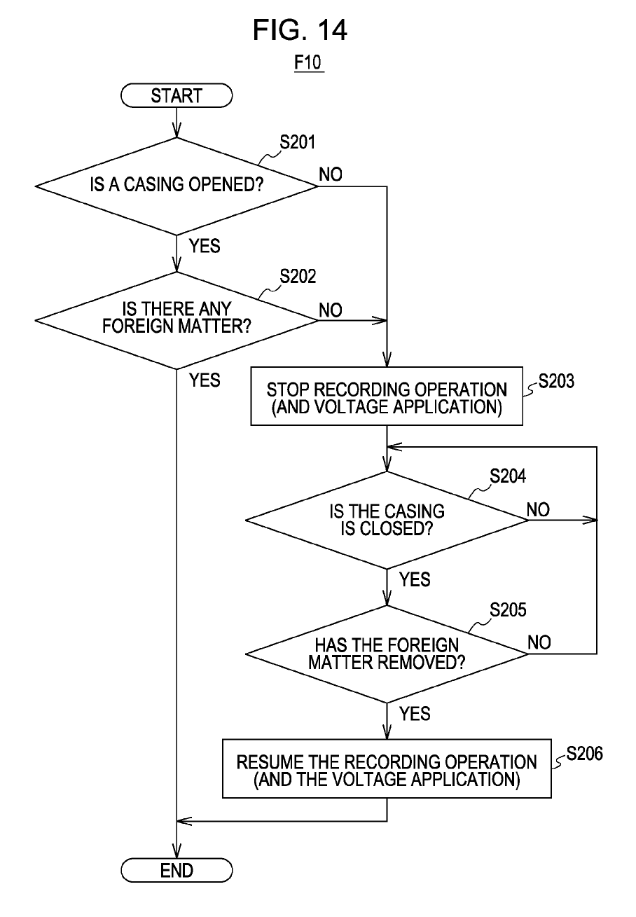

FIG. 14 is a flow chart illustrating sequence of additional controls of temporarily suspending voltage application during the above-described a series of recording operations. As shown in the figure, in Step S108, the control unit 260 monitors whether the upper casing 122 of the recording reading multifunction device 100 is closed (Step S201) even while the recording operation is continued.

Here, in the case in which the upper casing 122 is opened for some reason (Step S201: NO), the control unit 260 stops the voltage application in the case in which a voltage is applied by the voltage source 270 (Step S203) as well as the control unit 260 stops the recording operation. With such a structure, it is possible to prevent the recording operation from being executed with the recording head exposed in the state in which the upper casing 122 is opened. Further, it is possible to prevent members, to which the voltage is applied by the voltage source 270, from being in uncovered state, thereby preliminarily preventing electrical shock from occurring.

The control unit 260 monitors existence of foreign matter in the recording unit 110 (Step S202). In the case in which it is found that the foreign matter exists in the recording unit 110 (Step S202: NO), the control unit 260 stops the recording operation and the voltage application in the case in which a voltage is applied by the voltage source S270 (Step S203).

In the case in which foreign matter exists in the recording unit 110 during the operation, it happens that damage is caused to the recording unit 110 in the case in which the recording operation is continued as well as the normal recording operation cannot be executed. Further, in the case in which the voltage is applied by the voltage source 270, it happens that the nozzle plate 252 and the electrode 310 are short-circuited due to the foreign matter. In addition, if a user puts his or her hand in the recording unit 110 while the voltage is applied, the user may get an electric-shock. Accordingly, if the foreign matter is preliminarily detected, it is possible to prevent such damages from occurring by stopping the recording operation and the voltage application.

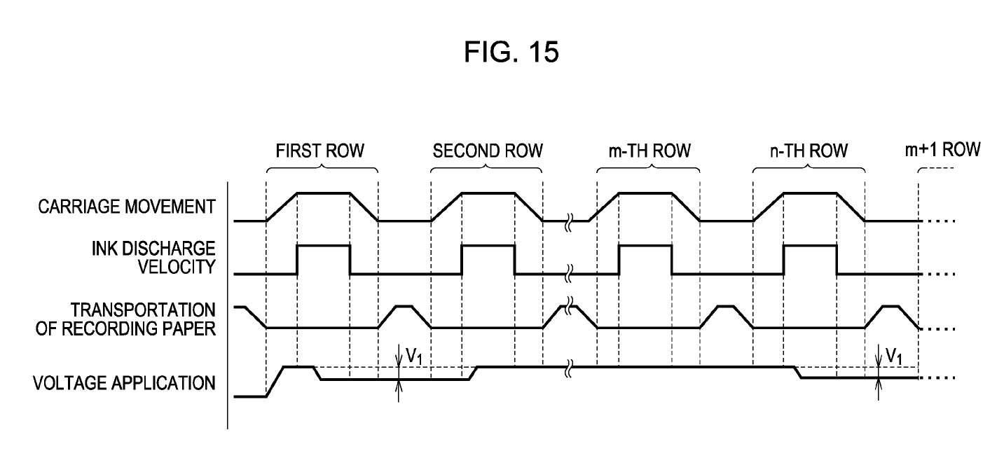

FIG. 15 is a view illustrating operation timings in different operation condition in the recording unit 110. As indicated by an arrow V₁ in the figure, the operation condition includes a period in which a voltage applied to the aerosol collecting mechanism 300 in order to form an electric field is lower than that as in the case shown in FIG. 12. This operation condition corresponds to the case in which an object to be recorded includes a region with no image, a region where the color (for example, white) of the recording paper 150 is needed to be directly used, or a region to express a white image.

In the case in which an image to be recorded is a mixture of photographs, characters, and graphs, or in the case in which such an image is needed to be recorded over to the edges of the recording paper 150 without leaving no margin, there can be the probability that the ink discharged from the nozzle plate 252 changes in the size of liquid droplets. That is, the size of liquid droplets is set to be relatively small in a photograph region, but the size of the liquid droplets is set to be relatively large in a graph region. As larger liquid droplets have larger charge, it is possible to impart sufficient kinetic energy to the liquid droplets with only a weak electric field.

In FIG. 15, the application voltage starts to be decreased from a midway point of a period corresponding to a first row and is restored to initial voltage from a midway point of a period corresponding to a second row. In FIG. 15, the application voltage is continuously decreased over periods of m-th row to n-th row, and is then maintained at the constant level from a period of (n+1)-th row. Such delicate control of the voltage source 270 is executed by the control unit 260 with reference to information on the image to be recorded.

As described above, with the balance between the power supplied to the aerosol collecting mechanism 300 and the discharge velocity of the ink from the recording head, it is possible to effectively suppress the increase of the satellite ink attributable to the excessive flight velocity and the increase of sprays attributable to collision with the absorbing member by properly maintaining the flight velocity of the ink flying in the form of liquid droplets.

Here, an ink jet type recording device mounted in the recording reading multifunction device 100 as the recording unit 110 is exemplified as an example of the liquid ejecting apparatus. However, further exemplified as the liquid ejecting apparatus is a color filter manufacturing device of a liquid display, which has a color material ejecting head serving as the liquid ejecting head, an electrode forming device of an organic EL display, a field emission display (FED), and the like, which has an electrode material (conductive paste) ejecting head serving as the liquid ejecting head, and a bio chip manufacturing device having a bio-organic substance ejecting head serving as the liquid ejecting head and a precision pipette. Here, the recording object means general media to which the liquid ejected from the liquid ejecting head can be attached, and examples thereof include printed circuit boards, disk-type optical recording media, preparations, and the like.

Further, the invention is described using embodiments but the technical scope of the invention is not limited to the embodiments. It will be apparent to those skilled in the art that various modifications and variations may be made in the embodiments without departing from the spirit or scope of the invention. Thus, it is intended that the present invention cover the modifications and variations of this invention provided they come within the scope of the appended claims.

1. A liquid ejecting apparatus, comprising:
a liquid ejecting head including a conductive nozzle plate having orifices and ejecting liquid from the orifices toward a recording object;
an absorbing member disposed at a position farther from the liquid ejecting head than location of the recording object in a liquid ejecting direction so as to face the nozzle plate, and absorbing the liquid which is ejected from the liquid ejecting head but is not attached to the recording object;
a potential difference creating unit creating a potential difference between the nozzle plate and the electrode by applying a voltage to the electrode so as to form an electric field, thereby making the liquid ejected from the liquid ejecting head be electrically attracted to the electrode; and
a liquid collection control unit performing switching of the potential differences with respect to the electrodes; and
a liquid ejecting head control unit which is a liquid ejecting head control unit controlling operation of the liquid ejecting head so the liquid ejecting head to eject the liquid and which performs switching of driving conditions in association with the switching of the potential differences, which is performed by the liquid collection control unit.

2. The liquid ejecting apparatus according to claim 1, wherein the liquid collection control unit enables a first potential difference and a second potential difference which is larger than the first potential difference to be switched to each other, and wherein the liquid ejecting head control unit ejects the liquid under a first driving condition so as to respond to the first potential difference, and ejects the liquid under a second driving condition so as to respond to the second potential difference, in which the second driving condition is slower than the first driving condition with respect to an initial velocity is the liquid which is being ejected and is substantially the same as the first driving condition with respect to an amount of ejected liquid.

3. The liquid ejecting apparatus according to claim 2, wherein an arrival velocity of the liquid at the recording object, the liquid ejected under a condition of the first potential difference and under the first driving condition with the first potential difference, is almost the same as an arrival velocity of the ejected liquid at the recording object, the liquid ejected under a condition of the second potential difference and under the second driving condition.

4. The liquid ejecting apparatus according to claim 1, wherein the liquid ejecting head control unit performs switching of driving signals supplied to a driving element which imparts a pressure to the liquid in the orifices.

5. The liquid ejecting apparatus according to claim 1, wherein the liquid collection control unit stops voltage application when a case body of the liquid ejecting device is opened.

6. The liquid ejecting apparatus according to claim 1, wherein the liquid collection control unit stops the voltage application when which it is detected that foreign matter other than the recording object exists in the case body.

7. The liquid ejecting apparatus according to claim 2, wherein the liquid ejecting head control unit performs switching of driving signals supplied to a driving element which imparts a pressure to the liquid in the orifices.

8. The liquid ejecting apparatus according to claim 3, wherein the liquid ejecting head control unit performs switching of driving signals supplied to a driving element which imparts a pressure to the liquid in the orifices.

9. The liquid ejecting apparatus according claim 2, wherein the liquid collection control unit stops voltage application when a case body of the liquid ejecting device is opened.

10. The liquid ejecting apparatus according claim 3, wherein the liquid collection control unit stops voltage application when a case body of the liquid ejecting device is opened.

11. The liquid ejecting apparatus according claim 4, wherein the liquid collection control unit stops voltage application when a case body of the liquid ejecting device is opened.

12. The liquid ejecting apparatus according to claim 2, wherein the liquid collection control unit stops the voltage application when which it is detected that foreign matter other than the recording object exists in the case body.

13. The liquid ejecting apparatus according to claim 3, wherein the liquid collection control unit stops the voltage application when which it is detected that foreign matter other than the recording object exists in the case body.

14. The liquid ejecting apparatus according to claim 4, wherein the liquid collection control unit stops the voltage application when which it is detected that foreign matter other than the recording object exists in the case body.

15. The liquid ejecting apparatus according to claim 5, wherein the liquid collection control unit stops the voltage application when which it is detected that foreign matter other than the recording object exists in the case body.
